(19) United States
(12) Patent Application Publication
(10) Pub. No.: US 2014/0227485 A1
(43) Pub. Date: Aug. 14, 2014

(54) COMPOSITE PROFILE AND PRODUCING METHOD THEREOF

(71) Applicant: KAITEYA GmbH, Bergisch Gladbach (DE)

(72) Inventor: Hong GAO, Bergisch Gladbach (DE)

(73) Assignee: KAITEYAH GmbH, Bergisch Gladbach (DE)

(21) Appl. No.: 14/252,509

(22) Filed: Apr. 14, 2014

Related U.S. Application Data
(63) Continuation of application No. PCT/CN2012/073379, filed on Mar. 31, 2012.

(30) Foreign Application Priority Data
Oct. 14, 2011 (CN) 201110313088.9
Oct. 14, 2011 (CN) 201120392316.1

(51) Int. Cl. E04C 2/26; B05D 3/00

(52) U.S. Cl. CPC E04C 2/26; B05D 3/002
USPC 428/151; 264/173.17; 427/301; 428/516; 428/518; 428/461

(57) ABSTRACT

A wood-fiber aluminum-plastic composite profile and a producing method thereof is provided. The profile comprises: an inner core made from minerals, plant fibers, additive and a type of waste plastic, and a protective film layer on the outer surface of the inner core made from a type of plastic identical to that of the inner core. The producing method comprises: adding raw material in weight ratio with main material of 30-55%, supplement material of 38-55%, filler of 5-30%, and additive of 2-6% in a mixer, processing into particles, and co-extruding the inner core and the protective film layer synchronously. The profile produced by the method has good quality, long service life, high durability and wide application range.

This nonprovisional application is a continuation of International Application No. PCT/CN2012/073379, which was filed on Mar. 31, 2012, and which claims priority to Chinese Patent Application No. CN 201120392316.1, which was filed on Oct. 14, 2011, and to Chinese Patent Application No. CN 201110313088.9, which was filed on Oct. 14, 2011, and which are all herein incorporated by reference.

### BACKGROUND OF THE INVENTION

1. Field of the Invention

The present invention relates to a wood-fiber aluminum-plastic composite profile and a producing method thereof, and in particular, to a wood-fiber aluminum-plastic composite profile produced with waste starting materials and a producing method thereof.

2. Description of the Background Art

An aluminum-plastic composite profile produced with waste plastics according to the prior art is produced as follows: mixing waste plastics, minerals, plant fibers, additives and other starting materials according to a ratio for hot melt, and producing then through extrusion molding with an extruder. The profile is thick and heavy, has high strength, saves steel lining, and provides a path of recyclable utilization for waste plastics and agricultural wastes. The wastes are used and become valuable, which achieves multiple purposes.

However, such a type of profiles has some drawbacks: (1) As they are made by compounding starting materials, such as minerals, plant fibers, and additives, with waste plastics, rather than by a single plastic starting material, the profiles have loose texture, poor air-tightness, tiny holes all over the surface, poor waterproofness, poor resistance to elements, poor resistance to wind, sunlight and rain, no resistance to moisture and sudden temperature change, tendency to develop mould in the presence of moisture, and short service life; (2) As they are made by compounding starting materials, such as minerals, plant fibers, and additives, with waste plastics, rather than by a single plastic starting material, the profiles have rough surface and dull and dark color. They are not beautiful, and when a decorative layer is attached to the outer surface, it is difficult to find a bonding agent that matches the interface properties due to the poor firmness of the profile surface and because that the interface is not formed by a single starting material. The bond is not firm and tends to break apart.

In addition, the inventor discloses in Chinese Patent 200510116789.8 (Method for Producing Green and Environmentally Friendly Hollow Composite Aluminum Foil Profile) a method that utilizes thermoplastic waste plastics to produce an aluminum-plastic composite profile. The method mainly comprises the following steps of: (1) selecting and matching materials, (2) crushing and mixing the materials, (3) extruding ribbon-like mixtures, (4) forging and stamping rough profiles, (5) machining the profiles, (6) coating, and (7) applying a metal coating. However, it has been found through production that this method still has some drawbacks:

The detailed description will be provided below:

Starting materials do not include mineral fillers, and only plant fibers and plastics are mixed. The plant fibers may enhance the tensile strength and flexibility, but have high brittleness, low strength, and poor resistance to elements. They are impacted greatly by sunlight and moisture, have low resistance to aging, and are easy to break.

Improper starting materials are selected. If PS and LDPE are selected therefrom as starting materials, the product will have problems like decreased strength, shortened service life, the coated aluminum layer tends to delaminate, and the bonding is not firm.

Complicated production process. In Step 3 thereof, the profiled extruded from the extruder is rough product, which further requires a rolling machine to coat a layer (Step 6), the hollow profile that is formed through machining is sent into the coating pipe, and after partial hardening through a cooling tank, the coated layer is flattened in vacuum. To use a rolling machine to coat a layer, Step 4: forging and stamping rough profiles and Step 5: machining the profiles need to be carried out first to adjust the specifications and dimensions of the profile. Only in such a way can Step 6 be carried out by sending the profile into the coating pipe. There are a number of apparatuses and complicated processes. Even with such complicated processes, the inner core (the rough profile obtained in Step 3) and the outer metal aluminum foil layer could be adversely affected since the coating materials are not carefully selected.

With respect to the inner core, since the plastic starting material used in Step 3 is not the same as the plastic starting material used in Step 6, the thermoplastic properties are not consistent and they cannot be bonded by a bonding agent, but can only be hot rolled and ironed with a coating by a rolling machine, which cannot integrate the inner core and the coating material into one piece very well.

With respect to the outer metal aluminum foil layer, since the plastic starting materials used in Step 6 are not a single plastic starting material, nor new materials, but regenerated waste plastics (all plastics with various colors are waste plastics, while new plastics are white or transparent). This will result in a problem that the current bonding agent is difficult to bond aluminum foil with waste plastics mixed with colors. Since the coating starting materials are not a single starting material, the material surface has poor density, is coarse and has a lot of micropores, which is difficult to firmly bond with the bonding agent. It is easy to delaminate, peel off, and generate bubbles, which further affect the integrity and quality of the profile, as well as starting material sorting in another recycle (due to the different melting points of the starting materials), leading to improper recycle and unfavorable for environmental protection. Moreover, the product is impacted greatly by sunlight and moisture, has low resistance to aging, and is easy to break.

### SUMMARY OF THE INVENTION

To solve the above problems, one object of the present invention is to provide a wood-fiber aluminum-plastic composite profile. The product has a beautiful appearance, good resistance to elements, is water proof and moisture proof, is capable of firm bonding with a decorative layer, does not delaminate, has long service life and high durability.

Another object of the present invention is to provide a method for producing the wood-fiber aluminum-plastic composite profile. This method produces high quality construction profiles by means of co-extruding, which has firm bonding, long service life, high durability and wide application range.

To attain the above objects, the present invention employs the following technical solution:

A wood-fiber aluminum-plastic composite profile, comprising an inner core made from minerals, plant fibers, additive and a single type of waste plastic, a protective film layer is disposed on the outer surface of the inner core, wherein the protective film layer fully encompasses the outer surface of the inner core and is made of a new plastic film of a single type, wherein the plastic of the protective film layer and the plastic of the inner core are of the same type.

A decorative layer is affixed to an outer side of the protective film layer.

The decorative layer is formed by an aluminum foil.

The decorative layer is formed by a wood grained film.

The decorative layer is formed by a veneer.

A method for producing a wood-fiber aluminum-plastic composite profile, comprising:

A first stage of feedstock preparation, which comprises: Providing a waste plastic or new plastic as a main feedstock, which is any one selected from polypropylene, polyethylene, polyvinyl chloride, and/or HDPE; Providing a plant fiber as an auxiliary feedstock, wherein the plant fiber is crushed into a 40-80 mesh powder with a rolling machine; Providing a 300-800 mesh mineral powder as the filler; Providing a chemical reagent capable of coupling action as an additive;

A second stage of mixing materials,

Wherein 30-55 wt % of the main feedstock, 38-55 wt % of the auxiliary feedstock, 5-30 wt % of the filler, and 2-6 wt % of the additive are loaded into a mixer, heated and mechanically mixed, and then granulated into particles, which are for later use as a starting material for the production of the inner core of the profile body;

A third stage of production of the profile body through a production line with co-extruding apparatuses, which comprises:

feeding the starting material obtained in the second stage into a hopper of an extruder for the production of the inner core of the profile body, feeding at the same time a new plastic of the same type as the main feedstock as a starting material for the protective film layer into another hopper of the extruder, starting the extruder, use a co-extruding mold to extrude the melted starting material for the inner core and the starting material for the protective film layer in a co-extruding manner to carry out the extrusion of the inner core and the protective film layer synchronously, and then cooling and molding in a cooling-forming-machine to thereby forming the profile body, wherein during the co-extruding process, the inner core and the protective film layer are tightly combined into one piece since they have consistent thermoplastic properties.

After the third stage is completed, continue to carry out a fourth stage of film lamination, which comprises:

Apply a bonding agent on an aluminum foil or wood grained film, place the aluminum foil or wood grained film onto a working position of a coating machine, and place the profile body obtained in the third stage on a slide track at an inlet of the coating machine, passing the profile body into the coating machine by a conveyor, bonding the aluminum foil or wood grained film to the profile body in the coating machine via hot melting, and outputting the profile as a product having a decorative layer.

Said plant fiber is a combination of one or more selected from tree barks, bamboo skin, saw dust, straw, flax, ramee, and/or stalks.

Said mineral powder is one or two selected from lime powder, asbestos powder, mica powder, chalk powder, talcum powder, calcium carbonate and/or glass fiber powder.

The wood-fiber aluminum-plastic composite profile according to the present invention has the following positive and beneficial effects:

The profile body according to the present invention includes an inner core and a protective film layer, the protective film layer plays a role of interface, which has the advantage of protecting both inside and outside. For the inner core, the protective film layer is an external interface of the inner core that fully wraps the inner core. The protective film layer is made of a pure (a single type and new) plastic. The pure plastic is dense and firm. It has high ductility, good air-tightness, good waterproofness, good resistance to elements, good resistance to wind, sunlight and rain, resistance to moisture erosion and sudden temperature change, and can protect the inner core very well. The type of the plastic for the protective film layer is the same as that for the inner core. Although one is old and the other is new, they have the same thermoplastic properties, which can be bonded integrally by means of co-extruding, facilitating the simplification of production processes and improvement of the yield.

The protective film layer is made of a pure plastic film, which has a beautiful appearance that completely shields the inner core with a coarse surface and dull and dark color, leading to a beautiful effect.

To the external decorative layer, the protective film layer is an internal interface. Since the protective film layer is made of a pure (a single type and new) plastic, it is very easy to pick a bonding agent with matching properties to those of the protective film layer for bonding with the external decorative layer. The bonding is firm and does not tend to delaminate.

The producing method according to the present invention has the following positive and beneficial effects: A mineral filler is added into the starting materials. While tensile strength and flexibility are enhanced by mixing plant fibers and plastics, the mineral filler enhances the strength and impact resistance of the profile, which further improves the flexibility such that the profile does not easily break; and Material selection is more scientific, reasonable and precise, and further follows the principle of polymer chemical reactions. In terms of the selection of plastic types for the inner core, only a single type of plastic starting material, rather than multiple types of plastic starting materials, is used. The objectives are: first, there is one melting point, which facilitates starting material sorting in another recycle. The recycled use is convenient and favorable for environmental protection. Second, the thermoplastic properties are consistent, which facilitates the attachment of a protective film layer capable of protection to the inner core by means of co-extruding. The protective film layer and the inner core have the same thermoplastic properties, leading to a firm bonding and eliminating the need of lamination through hot rolling and ironing by a rolling machine. The formation of a protective film layer for the inner core by means of co-extruding is significantly advantageous to the formation of a protective film layer by means of lamination. The protective film layer for the inner core formed by means of co-extruding has better performance in resistance to rain, moisture, noise and wind pressure, and moreover, the air-tightness is enhanced and the resistance to elements is good.

Since the protective film layer uses a single type and new plastic, the material is uniform without impurities, which is also beneficial for the coating process on the further external layer (the decorative layer process). It is more favorable for selecting a proper bonding agent to bond a decorative layer. It is not easy to delaminate and to generate bubbles and peel off.

At the same time, it makes the process less complicated, saves energy, is environmentally friendly, reduces production cost, and is favorable for promotion and use.

The biggest advantage of the present invention is that a co-extruding method is proposed to attach a protective film layer to the surface of an inner core. It is difficult to apply the co-extruding process for different types of plastic resins. Therefore, the inner core and the protective film layer must choose the same plastic type.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 illustrates the structure of the profile body of the present invention.

FIG. 2 is an enlarged view of the part A in FIG. 1.

FIG. 3 illustrates the profile body shown in FIG. 1 prior to a decorative layer.

FIG. 4 is a side view of FIG. 4.

FIG. 5 illustrates the profile body shown in FIG. 1 after bonding to a decorative layer.

FIG. 6 is an enlarged view of the part B in FIG. 5.

### DETAILED DESCRIPTION

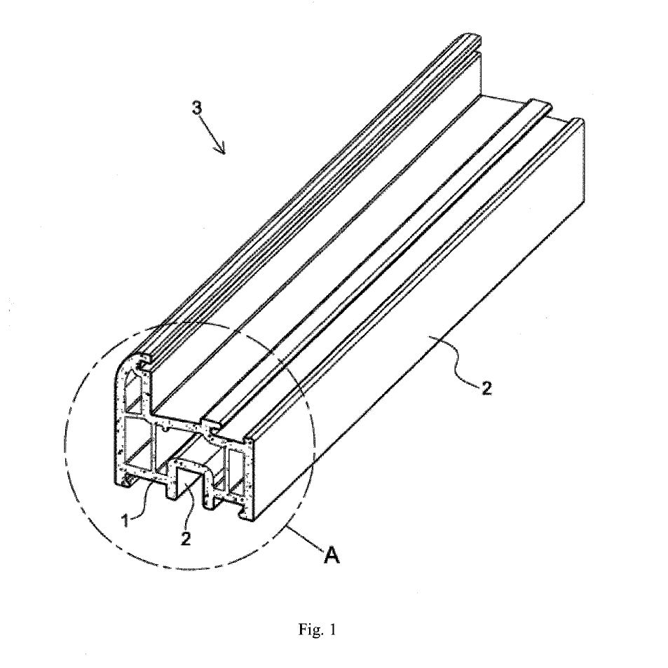

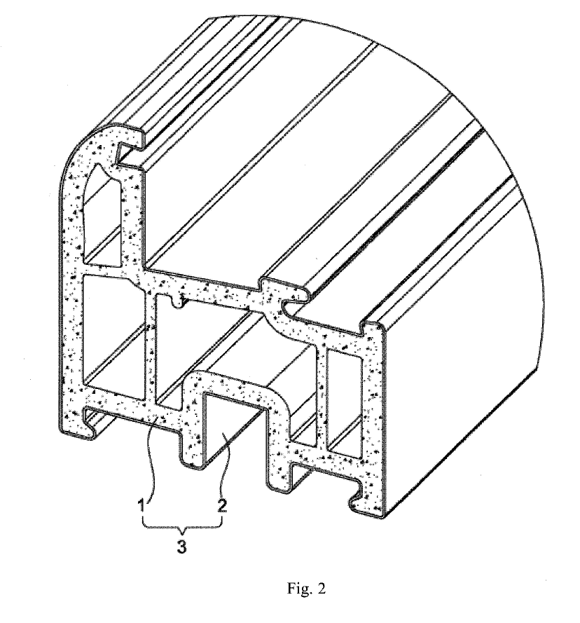

Please refer to FIG. 1 and FIG. 2, the wood-fiber aluminum-plastic composite profile according to the present invention comprises an inner core 1, the inner core 1 is made from minerals, plant fibers, additive capable of coupling action and a single type of waste plastic, the plant fiber may be one or two selected from tree barks, bamboo skin, saw dust, straw, flax, ramee, and/or stalks. The mineral powder is one or two selected from lime powder, asbestos powder, mica powder, chalk powder, talcum powder, calcium carbonate and/or glass fiber powder. The additive is maleic anhydride acid, commonly known as MSA. A protective film layer 2 is provided on the outer surface of the inner core 1. The protective film layer 2 is made of a pure plastic film, the protective film layer 2 fully encompasses the outer surface of the inner core 1, and the protective film layer 2 and the inner core 1 form the profile body 3.

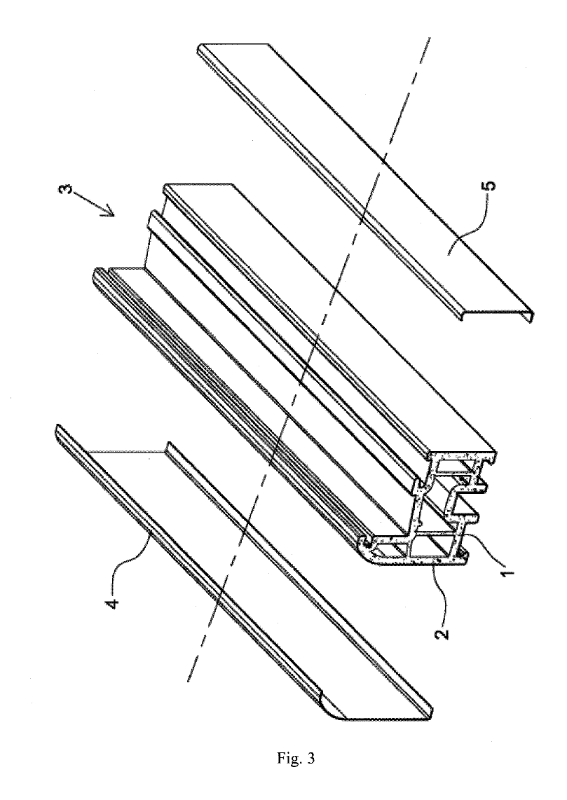

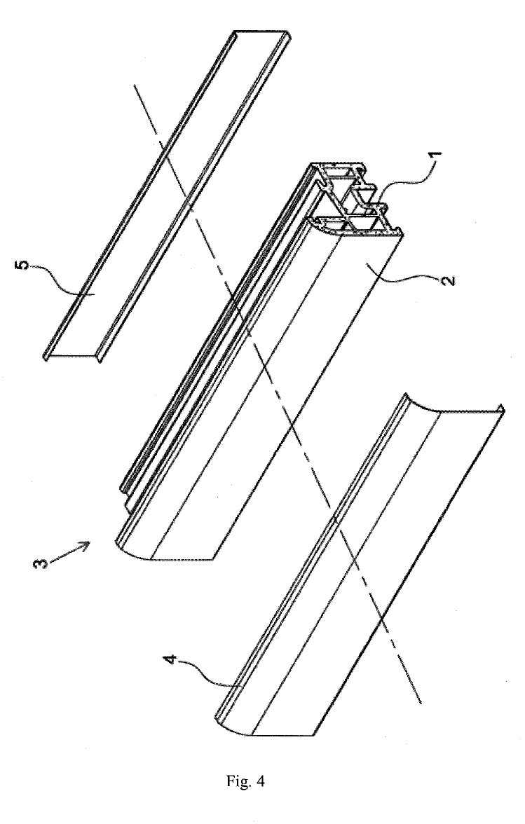

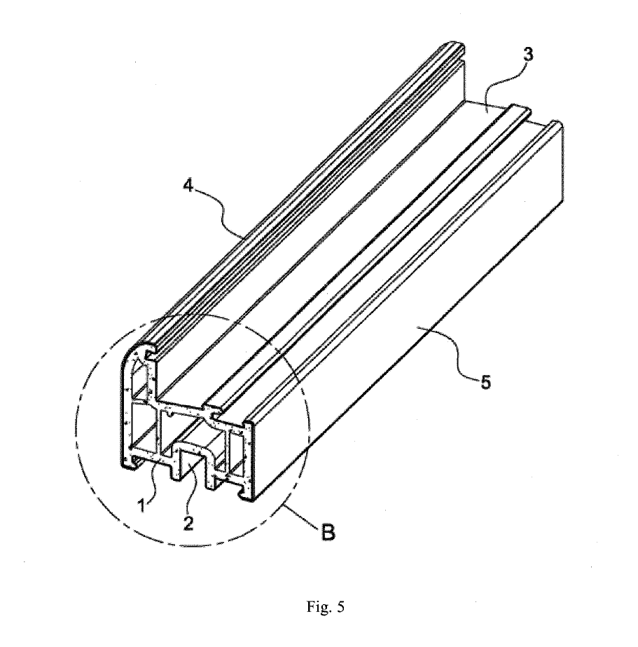

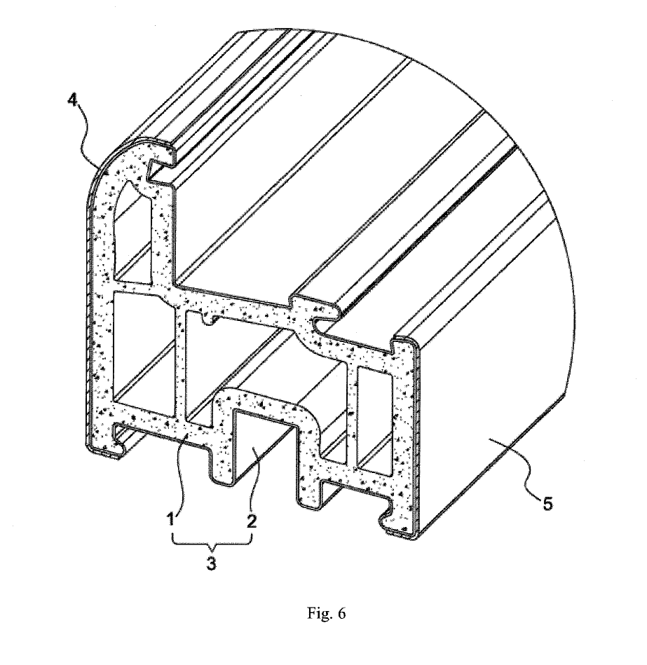

Please refer to FIG. 3, FIG. 4, FIG. 5, and FIG. 6, decorative layers 4 and 5 are attached to two sides (outdoor surface and indoor surface) of the profile body 3. The decorative layers 4 and 5 may be formed by aluminum foil. The decorative layers 4 and 5 may also be formed by a wood grained film. Moreover, the decorative layers 4 and 5 may also be formed by a veneer.

Types of plastics for the inner core 1 may include any one selected from PP (polypropylene), PE (polyethylene), PVC (polyvinyl chloride), and/or HDPE.

The type of plastics for the protective film layer 2 is the same as that for the inner core 1. For example, when the inner core 1 uses PP (old plastic), the protective film layer 2 is made of a pure PP (new plastic) film.

When the inner core 1 uses PE (old plastic), the protective film layer 2 is made of a pure PE (new plastic) film.

When the inner core 1 uses PVC (old plastic), the protective film layer 2 is made of a pure PVC (new plastic) film.

When the inner core 1 uses HDPE (old plastic), the protective film layer 2 is made of a pure HDPE (new plastic) film.

The protective film layer 2 plays a role of interface, which has the advantage of protecting both inside and outside. For the inner core 1, the protective film layer 2 is an external interface of the inner core 1, therefore it is made of a pure (a single type and new) plastic. The pure plastic is dense and firm. It has high ductility, good air-tightness, good waterproofness, good resistance to elements, good resistance to wind, sunlight and rain, resistance to moisture erosion and sudden temperature change, and can protect the inner core 1 very well. The type of the plastic for the protective film layer 2 is the same as that for the inner core 1. Although one is old and the other is new, they have the same thermoplastic properties, which can be easily bonded during production process, facilitating the simplification of production processes and improvement of the yield.

The protective film layer 2 is made of a pure plastic film, which has a beautiful appearance that completely shields the inner core 1 with a coarse surface and dull and dark color, leading to a beautiful effect.

To the external decorative layers 4 and 5, the protective film layer 2 is an internal interface. Since the protective film layer 2 is made of a pure (a single type and new) plastic, it is very easy to pick a bonding agent with matching properties to those of the protective film layer for bonding with the external decorative layers 4 and 5. The bonding is firm and does not tend to delaminate.

The method for producing the wood-fiber aluminum-plastic composite profile according to the present invention has the following specific embodiments:

### EXAMPLE I

The present invention provides a method for producing a wood-fiber aluminum-plastic composite profile, comprising:

A first stage of feedstock preparation, which comprises: Providing a thermoplastic waste plastic of PP (Polypropylene) as the main feedstock, and the main feedstock may be recycled plastic containers, such as plastic bottles, plastic cylinders and plastic cups, all of which are made of PP. Crushing the above plastic bottles, plastic cylinders and plastic cups with a crushing machine, and extruding with an extruder to round plastic particles (as the main feedstock) with a uniform size for later use. The ball diameter of the plastic particles is 2 mm; Providing a plant fiber as an auxiliary feedstock, wherein the plant fiber is saw dust and the plant fiber is crushed into 40 mesh powder with a rolling machine; Providing a 300 mesh mineral powder as the filler, and the mineral powder is glass fiber powder; and Providing a chemical reagent capable of coupling action as an additive, and the additive is maleic anhydride acid (MSA).

A second stage of mixing materials:

Wherein 50 wt % of the main feedstock PP, 40 wt % of the auxiliary feedstock saw dust, 6 wt % of the filler glass fiber powder, and 4 wt % of the additive MSA are loaded into a mixer, heated and mechanically mixed, and then granulated into particles, which are for later use as a starting material for the production of the inner core of the profile body. The ball diameter of the plastic particles is 3 mm.

A third stage of production of the profile body through a production line with co-extruding apparatuses, which comprises:

The production line with co-extruding apparatuses comprises two parts. The first part is a single-screw or twin-screw extruder. A co-extruding mold is provided inside the extruder, and the co-extruding mold is a jacket mold. The second part is a cooling and forming machine,

feeding the starting material obtained in the second stage into a hopper of an extruder for the production of the inner core of the profile body, feeding at the same time a new plastic of the same type as the main feedstock as a starting material for the protective film layer into another hopper of the extruder, the starting material for the protective film layer is a new plastic (pure plastic) of PP, starting the extruder, use a co-extruding mold to extrude the melted starting material for the inner core and the starting material for the protective film layer in a co-extruding manner to carry out the extrusion of the inner core 1 and the protective film layer 2 synchronously, wherein during the co-extruding process, the inner core 1 and the protective film layer 2 are tightly combined into one piece since they have consistent thermoplastic properties, as shown in FIG. 1 and FIG. 2, with the advantages of firm bonding, high strength, being soundproof, good thermal insulation, good airtightness, waterproofness, and then cooling and molding in a cooling-forming-machine to thereby forming the profile body 3.

A fourth stage of film lamination, which comprises:

In the coating process, decorative layers 4 and 5 are attached to the profile body 3, as shown in FIG. 3 and FIG. 4, surfaces of the profile body 3 to be coated are the outdoor surface and indoor surface. In this example, the decorative layers 4 and 5 are aluminum foils.

Apply a bonding agent on an aluminum foil, place the aluminum foil onto a working position of a coating machine, and place the profile body 3 obtained in the third stage on a slide track at an inlet of the coating machine, passing the profile body 3 into the coating machine by a conveyor, bonding the aluminum foil to the profile body 3 in the coating machine via hot melting, and outputting the profile as a product having a decorative layer as shown in FIG. 5 and FIG. 6.

### EXAMPLE II

The present invention provides a method for producing a wood-fiber aluminum-plastic composite profile, comprising:

A first stage of feedstock preparation, which comprises: Providing a thermoplastic waste plastic of PE (Polyethylene) as the main feedstock, and the main feedstock may be recycled plastic containers, such as plastic bottles, plastic cylinders and plastic cups, all of which are made of PE. Crushing the above plastic bottles, plastic cylinders and plastic cups with a crushing machine, and extruding with an extruder to round plastic particles (as the main feedstock) with a uniform size for later use. The ball diameter of the plastic particles is 3 mm; Providing a plant fiber as an auxiliary feedstock, wherein the plant fiber is bamboo powder and the bamboo powder is crushed into 50 mesh powder with a rolling machine; Providing a 400 mesh mineral powder as the filler, and the mineral powder is asbestos powder; and Providing a chemical reagent capable of coupling action as an additive, and the additive is maleic anhydride acid (commonly known as MSA).

A second stage of mixing materials:

Wherein 55 wt % of the main feedstock PE, 38 wt % of the auxiliary feedstock bamboo powder, 5 wt % of the filler asbestos powder, and 2 wt % of the additive MSA are loaded into a mixer, heated and mechanically mixed, and then granulated into particles, which are for later use as a starting material for the production of the inner core of the profile body. The ball diameter of the plastic particles is 4 mm.

A third stage of production of the profile body through a production line with co-extruding apparatuses, which comprises:

The production line with co-extruding apparatuses comprises two parts,

The first part is a single-screw or twin-screw extruder. A co-extruding mold is provided inside the extruder, and the co-extruding mold is a jacket mold. The second part is a cooling and forming machine.

Feeding the starting material obtained in the second stage into a hopper of an extruder for the production of the inner core of the profile body, feeding at the same time a new plastic of the same type as the main feedstock as a starting material for the protective film layer into another hopper of the extruder, the starting material for the protective film layer is a new plastic (pure plastic) of PE, starting the extruder, use a co-extruding mold to extrude the melted starting material for the inner core and the starting material for the protective film layer in a co-extruding manner to carry out the extrusion of the inner core 1 and the protective film layer 2 synchronously, wherein during the co-extruding process, the inner core 1 and the protective film layer 2 are tightly combined into one piece since they have consistent thermoplastic properties, as shown in FIG. 1 and FIG. 2, with the advantages of firm bonding, high strength, being soundproof, good thermal insulation, good airtightness, waterproofness, and then cooling and molding in a cooling-forming-machine to thereby forming the profile body 3.

A fourth stage of film lamination, which comprises: in the coating process, decorative layers 4 and 5 are attached to the profile body 3, as shown in FIG. 3 and FIG. 4, surfaces of the profile body 3 to be coated are the outdoor surface and indoor surface. In this example, the decorative layers 4 and 5 are aluminum foils.

Apply a bonding agent on an aluminum foil, place the aluminum foil onto a working position of a coating machine, and place the profile body 3 obtained in the third stage on a slide track at an inlet of the coating machine, passing the profile body 3 into the coating machine by a conveyor, bonding the aluminum foil to the profile body 3 in the coating machine via hot melting, and outputting the profile as a product having a decorative layer as shown in FIG. 5 and FIG. 6.

### EXAMPLE III

The present invention provides a method for producing a wood-fiber aluminum-plastic composite profile, comprising:

A first stage of feedstock preparation, which comprises: Providing a thermoplastic waste plastic of HDPE as the main feedstock, and the main feedstock may be recycled plastic containers, such as plastic bottles, plastic cylinders and plastic cups, all of which are made of HDPE. Crushing the above plastic bottles, plastic cylinders and plastic cups with a crushing machine, and extruding with an extruder to round plastic particles (as the main feedstock) with a uniform size for later use. The ball diameter of the plastic particles is 4 mm; Providing a plant fiber as an auxiliary feedstock, wherein the plant fiber is flax and the flax is crushed into 60 mesh powder with a rolling machine; Providing a 500 mesh mineral powder as the filler, and the mineral powder is mica powder; and Providing a chemical reagent capable of coupling action as an additive, and the additive is maleic anhydride acid.

A second stage of mixing materials:

Wherein 30 wt % of the main feedstock HDPE, 38 wt % of the auxiliary feedstock flax, 30 wt % of the filler mica powder, and 2 wt % of the additive MSA are loaded into a mixer, heated and mechanically mixed, and then granulated into particles, which are for later use as a starting material for the production of the inner core of the profile body. The ball diameter of the plastic particles is 5 mm.

A third stage of production of the profile body through a production line with co-extruding apparatuses, which comprises:

The production line with co-extruding apparatuses comprises two parts,

The first part is a single-screw or twin-screw extruder. A co-extruding mold is provided inside the extruder, and the co-extruding mold is a jacket mold. The second part is a cooling and forming machine, feeding the starting material obtained in the second stage into a hopper of an extruder for the production of the inner core of the profile body, feeding at the same time a new plastic of the same type as the main feedstock as a starting material for the protective film layer into another hopper of the extruder, the starting material for the protective film layer is a new plastic (pure plastic) of HDPE, starting the extruder, use a co-extruding mold to extrude the melted starting material for the inner core and the starting material for the protective film layer in a co-extruding manner to carry out the extrusion of the inner core 1 and the protective film layer 2 synchronously, wherein during the co-extruding process, the inner core 1 and the protective film layer 2 are tightly combined into one piece since they have consistent thermoplastic properties, as shown in FIG. 1 and FIG. 2, with the advantages of firm bonding, high strength, being soundproof, good thermal insulation, good airtightness, waterproofness, and then cooling and molding in a cooling-forming-machine to thereby forming the profile body 3.

A fourth stage of film lamination, which comprises:

In the coating process, decorative layers 4 and 5 are attached to the profile body 3, as shown in FIG. 3 and FIG. 4, surfaces of the profile body 3 to be coated are the outdoor surface and indoor surface. In this example, the decorative layers 4 and 5 are formed by a wood grained film.

Apply a bonding agent on a wood grained film, place the wood grained film onto a working position of a coating machine, and place the profile body 3 obtained in the third stage on a slide track at an inlet of the coating machine, passing the profile body 3 into the coating machine by a conveyor, bonding the wood grained film to the profile body 3 in the coating machine via hot melting, and outputting the profile as a product having a decorative layer as shown in FIG. 5 and FIG. 6.

### EXAMPLE IV

The present invention provides a method for producing a wood-fiber aluminum-plastic composite profile, comprising:

A first stage of feedstock preparation, which comprises: Providing a thermoplastic waste plastic of PVC (Polyvinylchloride) as the main feedstock, and the main feedstock may be recycled plastic containers, such as plastic bottles, plastic cylinders and plastic cups, all of which are made of PVC. Crushing the above plastic bottles, plastic cylinders and plastic cups with a crushing machine, and extruding with an extruder to round plastic particles (as the main feedstock) with a uniform size for later use. The ball diameter of the plastic particles is 4 mm; Providing a plant fiber as an auxiliary feedstock, wherein the plant fiber is a mixture of bamboo powder and saw dust with each at 50% by weight, and the mixture of bamboo powder and saw dust is crushed into 70 mesh powder with a rolling machine; Providing an 800 mesh mineral powder as the filler, and the mineral powder is chalk powder; and Providing a chemical reagent capable of coupling action as an additive, and the additive is maleic anhydride acid.

A second stage of mixing materials:

Wherein 45 wt % of the main feedstock PVC, 45 wt % of the auxiliary feedstock mixture of bamboo powder and saw dust, 6 wt % of the filler chalk powder, and 4 wt % of the additive MSA are loaded into a mixer, heated and mechanically mixed, and then granulated into particles, which are for later use as a starting material for the production of the inner core of the profile body. The ball diameter of the plastic particles is 6 mm.

A third stage of production of the profile body through a production line with co-extruding apparatuses, which comprises:

The production line with co-extruding apparatuses comprises two parts, the first part is a single-screw or twin-screw extruder. A co-extruding mold is provided inside the extruder, and the co-extruding mold is a jacket mold. The second part is a cooling and forming machine, feeding the starting material obtained in the second stage into a hopper of an extruder for the production of the inner core of the profile body, feeding at the same time a new plastic of the same type as the main feedstock as a starting material for the protective film layer into another hopper of the extruder, the starting material for the protective film layer is a new plastic (pure plastic) of PVC, starting the extruder, use a co-extruding mold to extrude the melted starting material for the inner core and the starting material for the protective film layer in a co-extruding manner to carry out the extrusion of the inner core 1 and the protective film layer 2 synchronously, wherein during the co-extruding process, the inner core 1 and the protective film layer 2 are tightly combined into one piece since they have consistent thermoplastic properties, as shown in FIG. 1 and FIG. 2, with the advantages of firm bonding, high strength, being soundproof, good thermal insulation, good airtightness, waterproofness, and then cooling and molding in a cooling-forming-machine to thereby forming the profile body 3.

A fourth stage of film lamination, which comprises:

In the coating process, decorative layers 4 and 5 are attached to the profile body 3, as shown in FIG. 3 and FIG. 4, surfaces of the profile body 3 to be coated are the outdoor surface and indoor surface. In this example, the decorative layers 4 and 5 are formed by a wood grained film. Apply a bonding agent on a wood grained film, place the wood grained film onto a working position of a coating machine, and place the profile body 3 obtained in the third stage on a slide track at an inlet of the coating machine, passing the profile body 3 into the coating machine by a conveyor, bonding the wood grained film to the profile body 3 in the coating machine via hot melting, and outputting the profile as a product having a decorative layer as shown in FIG. 5 and FIG. 6.

### EXAMPLE V

The present invention provides a method for producing a wood-fiber aluminum-plastic composite profile, comprising:

A first stage of feedstock preparation, which comprises: Providing a waste plastic or new plastic of PE (Polyethylene) as the main feedstock, and the waste plastic may be recycled plastic containers, such as plastic bottles, plastic cylinders and plastic cups, all of which are made of PE. Crushing the above plastic bottles, plastic cylinders and plastic cups with a crushing machine, and extruding with an extruder to round plastic particles (as the main feedstock) with a uniform size for later use. The ball diameter of the plastic particles is 3 mm; Providing a plant fiber as an auxiliary feedstock, wherein the plant fiber is straw powder and the straw powder is crushed into 80 mesh powder with a rolling machine; Providing a 600 mesh mineral powder as the filler, and the mineral powder is talcum powder; and Providing a chemical reagent capable of coupling action as an additive, and the additive is maleic anhydride acid.

A second stage of mixing materials:

Wherein 40 wt % of the main feedstock PE, 46 wt % of the auxiliary feedstock straw powder, 10 wt % of the filler talcum powder, and 4 wt % of the additive MSA are loaded into a mixer, heated and mechanically mixed, and then granulated into particles, which are for later use as a starting material for the production of the inner core of the profile body. The ball diameter of the plastic particles is 4 mm.

A third stage of production of the profile body through a production line with co-extruding apparatuses, which comprises:

The production line with co-extruding apparatuses comprises two parts,

The first part is a single-screw or twin-screw extruder. A co-extruding mold is provided inside the extruder, and the co-extruding mold is a jacket mold. The second part is a cooling and forming machine.

Feeding the starting material obtained in the second stage into a hopper of an extruder for the production of the inner core of the profile body, feeding at the same time a new plastic of the same type as the main feedstock as a starting material for the protective film layer into another hopper of the extruder, the starting material for the protective film layer is a new plastic (pure plastic) of PE, starting the extruder, use a co-extruding mold to extrude the melted starting material for the inner core and the starting material for the protective film layer in a co-extruding manner to carry out the extrusion of the inner core 1 and the protective film layer 2 synchronously, wherein during the co-extruding process, the inner core 1 and the protective film layer 2 are tightly combined into one piece since they have consistent thermoplastic properties, as shown in FIG. 1 and FIG. 2, with the advantages of firm bonding, high strength, being soundproof, good thermal insulation, good airtightness, waterproofness, and then cooling and molding in a cooling-forming-machine to thereby forming the profile body 3.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A composite profile comprising:
an inner core made from minerals, plant fibers, an additive and a single type of plastic; and
a protective film layer disposed on an outer surface of the inner core,
wherein the protective film layer fully encompasses the outer surface of the inner core and is made of a new plastic film of a single type, and
wherein the plastic of the protective film layer and the plastic of the inner core are of the same type.

2. The composite profile as set forth in claim 1, wherein a decorative layer is affixed to an outer side of the protective film layer.

3. The composite profile as set forth in claim 2, wherein the decorative layer is formed by an aluminum foil.

4. The composite profile as set forth in claim 2, wherein the decorative layer is formed by a wood grained film.

5. The composite profile as set forth in claim 2, wherein the decorative layer is formed by a veneer.

6. The composite profile as set forth in claim 1, wherein the plastic for the core is chosen from waste plastic and/or new plastic.

7. The composite profile as set forth in claim 1, wherein the core and the protective film layer are made in a co-extruding manner, and wherein the core and the protective film layer are tightly combined into one piece only based on the co-extruding principle.

8. The composite profile as set forth in claim 1, wherein the plant fibers are chosen from one material or a combination of materials selected from tree material, bamboo, saw dust, straw, flax, ramee, or stalks.

9. The composite profile as set forth in claim 1, wherein the minerals are chosen from one or more materials of lime powder, asbestos powder, mica powder, chalk powder, talcum powder, calcium carbonate or glass fiber powder.

10. The composite profile as set forth in claim 1, wherein the additive comprises maleic anhydride acid (MSA).

11. A method for producing a composite profile, the method comprising:
a first stage of feedstock preparation, which comprises:
providing a waste plastic or new plastic as a main feedstock, which is any one selected from polypropylene, polyethylene, polyvinyl chloride, or HDPE;
providing a plant fiber as an auxiliary feedstock, wherein the plant fiber is crushed into a 40-80 mesh powder with a rolling machine;
providing a 300-800 mesh mineral powder as the filler; and
providing a chemical reagent capable of coupling action as an additive;
a second stage of mixing materials, wherein 30-55 wt % of the main feedstock, 38-55 wt % of the auxiliary feedstock, 5-30 wt % of the filler, and 2-6 wt % of the additive are loaded into a mixer, heated and mechanically mixed, and then granulated into particles, which are for later use as a starting material for the production of the inner core of the profile body; and
a third stage of production of the profile body through a production line with co-extruding apparatuses, which comprises feeding the starting material obtained in the second stage into a hopper of an extruder for the production of the inner core of the profile body, feeding at the same time a new plastic of the same type as the main feedstock as a starting material for the protective film layer into another hopper of the extruder, starting the extruder, use a co-extruding mold to extrude the melted starting material for the inner core and the starting material for the protective film layer in a co-extruding manner to carry out the extrusion of the inner core and the protective film layer synchronously, and then cooling and molding in a cooling-forming-machine to thereby forming the profile body, wherein during the co-extruding process, the inner core and the protective film layer are tightly combined into one piece since they have consistent thermoplastic properties.

12. The method for producing the composite profile as set forth in claim 11, wherein the method comprises, after that the third stage is completed, a fourth stage of film lamination, which comprises applying a bonding agent on an aluminum foil or wood grained film, place the aluminum foil or wood grained film onto a working position of a coating machine, and place the profile body obtained in the third stage on a slide track at an inlet of the coating machine, passing the profile body into the coating machine by a conveyer, bonding the aluminum foil or wood grained film to the profile body in the coating machine via hot melting, and outputting the profile as a product having a decorative layer.

13. The method for producing the composite profile as set forth in claim 11, wherein said plant fiber is a combination of one or more selected from tree material, bamboo, saw dust, straw, flax, ramee, or stalks.

14. The method for producing the composite profile as set forth in claim 11, wherein said mineral powder is one or two selected from lime powder, asbestos powder, mica powder, chalk powder, talcum powder, calcium carbonate or glass fiber powder.

15. The method for producing the composite profile as set forth in claim 11, wherein the additive comprises maleic anhydride acid (MSA).
